(19) United States
(12) Patent Application Publication
(10) Pub. No.: US 2015/0120270 A1
(43) Pub. Date: Apr. 30, 2015

(54) APPARATUS AND METHOD FOR AUTOMATING SMART GRID COMMON INFORMATION MODEL INTEROPERABILITY TEST

(71) Applicant: ELECTRONICS AND TELECOMMUNICATIONS RESEARCH INSTITUTE, Daejeon (KR)

(72) Inventors: Tae In HWANG, Daejeon (KR); Il Woo LEE, Daejeon (KR)

(73) Assignee: ELECTRONICS AND TELECOMMUNICATIONS RESEARCH INSTITUTE, Daejeon (KR)

(21) Appl. No.: 14/268,543

(22) Filed: May 2, 2014

(30) Foreign Application Priority Data
Oct. 29, 2013 (KR) 10-2013-0128927

(51) Int. Cl. G06F 17/50

(52) U.S. Cl. CPC G06F 17/5009
USPC 703/18

(57) ABSTRACT

Disclosed are an apparatus and method for automating a smart grid interoperability test and verification. It is possible to allow a tester to easily establish a test environment needed to test a CIM interoperability by providing a function that allows a tester to directly set and create a test node, a CIM test sequence, and a test sequence metadata, and it is also possible to reduce time and cost taken to test and verify the CIM interoperability by automatically compare and analyze a CIM message monitored in an actual test process with CIM message metadata set in a test scenario creation stage.

### CROSS-REFERENCE TO RELATED APPLICATIONS

This application claims priority under 35 U.S.C. §119 to Korean Patent Application No. 10-2013-0128927, filed on Oct. 29, 2013, the disclosure of which is incorporated herein by reference in its entirety.

### TECHNICAL FIELD

The present invention relates to a technology for automating interoperability test in a centralized remote monitoring system of power generation, transmission, and distribution facilities, and more particularly, an apparatus and method for automating an interoperability test and verification by comparing a common information model (CIM) message set by a tester for each test stage of an interoperability test scenario with a CIM message created as a result of executing the test scenario.

### BACKGROUND

A smart grid refers to an intelligent power network that integrates information technology into the existing one-way power network, which consists of the generation, transmission and distribution, and sale of power, to optimize energy efficiency through a two-way exchange of electricity information between suppliers and consumers in real time. A basic concept of the smart grid is to efficiently operate as one body an entire power system by connecting the power plants, transmission and distribution facilities, and consumers over an information communication network and sharing information.

A power supplier may check a power consumption state in a real time using the smart grid to elastically control a supply amount of power. By checking a power consumption state in a real time, the consumer may appropriately control a time period of use and an amount of use to avoid an expensive time zone and may sell electricity generated at home, for example, with a solar cell, a fuel cell, or an electric motor.

Furthermore, since the smart grid is operated as an automatic control system, it is possible to minimize power failure by detecting a failure factor in advance. Unlike existing power system, since the smart grind is a distributed power system in which various power suppliers and consumers are directly connected, the utilization of new renewable energy having a limitation in that power generation depends on an amount of air flow, an amount of sunshine, etc. is increased. As the utilization of new renewable energy is increased, thermo power plants are replaced to reduce green house gases and contaminants, thereby assisting in solving environmental problems.

Thus many countries in the world are driving business to construct the smart grid as a next-generation power network. In South Korea, basic technologies for the smart grid are being developed by industry-university research institutes and experts since 2004, and in 2008, the smart grid was selected as a project for green energy business development strategies and Intelligent Power Network Construction Committee was founded in order to provide a legal and institutional basis.

In June 2009, ‘Korean Smart Grid Vision’ was released, which essentially consists of an advanced smart meter, that is, an advanced smart meter that optimizes the use of power by networking with home appliances and provides electricity bill information to a consumer in real time, an infrastructure for charging electric vehicles, a distributed power source (battery), a real-time electricity pricing system, a power network self-treatment function, a new renewable energy control function, direct current (DC) power source supply, and power quality selection.

In addition, the Korean government has selected Jeju special self-governing province as a Smart Grid Testbed, started technical demonstration in 2010, and performed large scale supply from 2011, and has a project to , focusing on a testbed city. Furthermore, the government plans to complete consumer intelligence up to 2020 and the entire power network intelligence up to 2030.

Smart Grid standards such as IEC 61970, IEC 61968, OpenADR, and SEP provide an energy management system (EMS), a distribution management system (DMS), and a standardized information model to homes, buildings and industrial facilities on the basis of common information model (CIM). In related art, in order to test interoperability among a device, a system, and an application, which are developed based on the common information model, a tester should configure a test environment for each a test scenario and directly monitor and manually check messages exchanged between test target nodes.

In this case, there are limitations in that when test scenarios are various and test stages for each test scenario are complicated, it may be difficult to establish an interoperability test environment and it may takes a lot of time and cost to determine whether the interoperability is appropriate since an expert directly analyzes a message monitored for each test stage to determine the appropriateness.

### SUMMARY

Accordingly, the present invention provides an apparatus and method for automating a smart grid common information model interoperability test, which can provide a function that allows a tester to set test target nodes, a common information model test scenario sequence, and metadata based on the test sequence in a test scenario creation stage.

The present invention also provides an apparatus and method for automating a smart grid common information model interoperability test and verification, which can automatically compare and analyze a common information model message monitored in an actual test process with metadata set in a test scenario creation stage.

The object of the present invention is not limited to the aforesaid, but other objects not described herein will be clearly understood by those skilled in the art from descriptions below.

In one general aspect, an apparatus for automating a smart grid common information model interoperability test, the apparatus includes: a common information model test scenario creation unit configured to provide a user interface for setting a test scenario environment in a smart grid environment including test target nodes such as an apparatus, a system, and an application; a scenario execution engine unit configured to execute a test scenario created by the common information model test scenario creation unit; a common information model message monitoring unit configured to monitor a common information model message, outputted from each of the test target nodes, as a result of the execution of the test scenario; and a common information model testing unit configured to compare the common information model message monitored by the common information model message monitoring unit with a user-defined common information model message set by the common information model test scenario creation unit.

The common information model test scenario creation unit may provide at least one of a user interface for setting test target nodes and a user interface for setting a test sequence between the test target nodes.

The common information model test scenario creation unit may provide a user interface for setting a common information model message created in a test scenario by the test target nodes.

The common information model message may be set for the test target nodes based on the test sequence in the test scenario.

The user-defined common information model message may be stored in a form of metadata.

The common information model testing unit may output a result of verifying a common information model message transmitted between the test target nodes based on the test sequence, using a sequence diagram.

The common information model scenario creation unit may provide a user interface for setting the test target nodes, a test sequence between the test target nodes, and a user interface for setting the common information model message created based on the test sequence by the test target nodes.

In another general aspect, a method of automating a smart grid common information model interoperability test, the method includes: performing a test scenario creation operation of providing a user interface for setting a test scenario environment in a smart grid environment including test target nodes such as an apparatus, a system, and an application; executing the created test scenario to monitor a common information model message outputted from each of the test target nodes; and performing a test result output operation of comparing the monitored common information model message with a user-defined common information model message set in the test scenario creation operation to automatically create a test result.

The test scenario creation operation may include: (a) setting the test target nodes; (b) setting a test sequence between the test target nodes; and (c) setting a common information model message created based on the test sequence by the test target nodes.

The test result output operation may include outputting a result of verifying whether the common information model message transmitted between the test target nodes is included in the user-defined common information model message, based on the test sequence, using a sequence diagram.

The test result output operation may include information on a source node that creates the common information model message based on the test sequence between the test target nodes, information on a destination node that receives the common information model message, the common information message information, and verification result information on whether the common information model message is included in the user-defined common information model message.

Other features and aspects will be apparent from the following detailed description, the drawings, and the claims.

### BRIEF DESCRIPTION OF THE DRAWINGS

FIG. 1 is a block diagram showing a configuration of an apparatus for automating a smart grid common information model interoperability test according to an embodiment of the present invention,

FIG. 2 is a flowchart showing a method of automating a smart grid common information model interoperability test according to an embodiment of the present invention.

FIG. 3 is a view showing an example of a user interface provided to set a test target node for test automation according to an embodiment of the present invention of FIG. 2.

FIG. 4 is a view showing an example of a user interface provided to set a test sequence for test automation according to an embodiment of the present invention of FIG. 2.

FIG. 5 is a view showing an example of a user interface provided to set common information model metadata based on the test sequence for test automation according to an embodiment of the present invention of FIG. 2.

FIG. 6a is a view showing an example of a user interface in which a test result is output according to an embodiment of the present invention of FIG. 2.

FIG. 6b is a view showing another example of a user interface in which a test result is output according to an embodiment of the present invention of FIG. 2.

FIG. 7a is a view showing an example of a test environment configuration established using an apparatus for automating a smart grid common information model interoperability test according to an embodiment of the present invention.

FIG. 7b is a view showing another example of a test environment configuration established using an apparatus for automating a smart grid common information model interoperability test according to an embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

FIG. 1 is a block diagram showing a configuration of an apparatus for automating a smart grid common information model interoperability test according to an embodiment of the present invention.

Referring to FIG. 1, the smart grid common information model interoperability test automation apparatus 100 according to the present invention includes a common information model (CIM) scenario creation unit 110, a scenario execution engine unit 120, a CIM message monitoring unit 130, and a CIM testing unit 140.

The CIM scenario creation unit 110 provides a user interface for setting a test scenario environment in a smart grid environment including test target nodes such as an apparatus, a system, and an application.

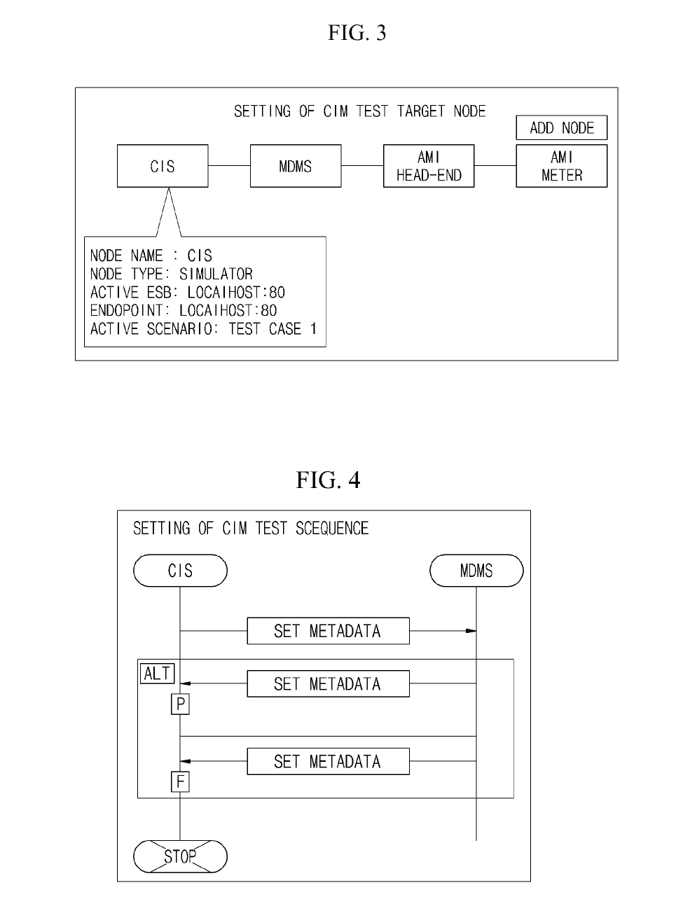

Specifically, the CIM scenario creation unit 110 provides a user interface for setting test target nodes, a test sequence between the test target nodes, and a user interface for setting a common information model message that can be created based on the test sequence by the test target nodes. Hereinafter, a user interface provided by the CIM scenario creation unit 110 will be described with reference to FIGS. 3 to 5.

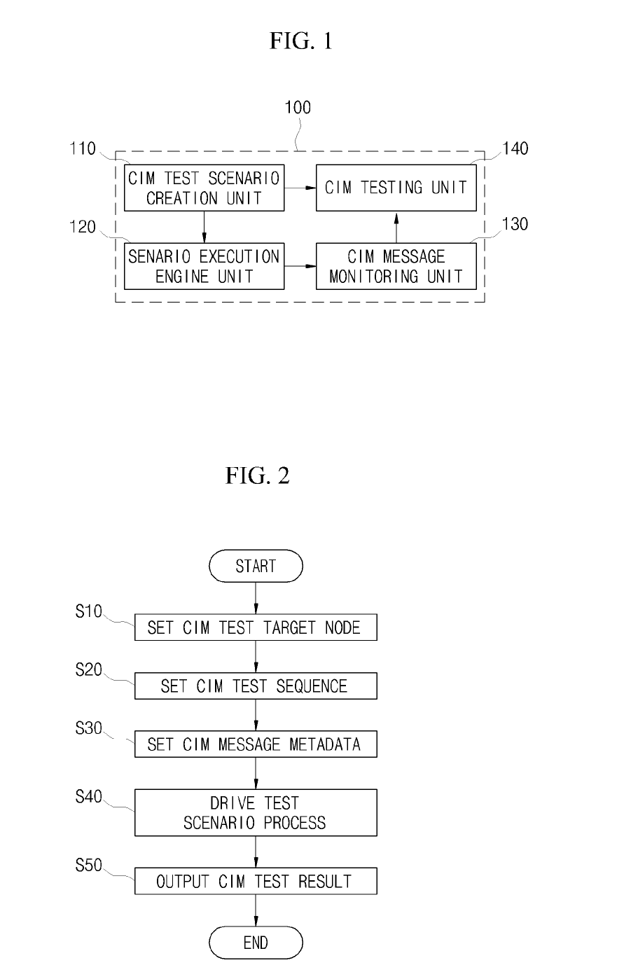

FIG. 3 is a view showing an example of a user interface provided to set a test target node for test automation according to an embodiment of the present invention of FIG. 2.

As shown in FIG. 3, the CIM scenario creation unit 110 may provide a user interface for setting test target nodes. Here, the user interface may be used to configure a test environment including a test target apparatus or simulator such as a customer information system (CIS), a metering system (AMI Head-End, AMI Meter), an outage management system, and a load management system and set configuration information for each node by using an editing button for adding or deleting CIM operability test target nodes.

FIG. 4 is a view showing an example of a user interface provided to set a test sequence for test automation according to an embodiment of the present invention of FIG. 2.

As shown in FIG. 4, the CIM scenario creation unit 110 may provide a user interface for setting a test sequence between the set test target nodes. Here, the user interface may be used to set a test sequence for verifying a CIM message for each test stage in order to test interoperability between the test target nodes such as a smart grid apparatus, system, and application in a smart grid environment.

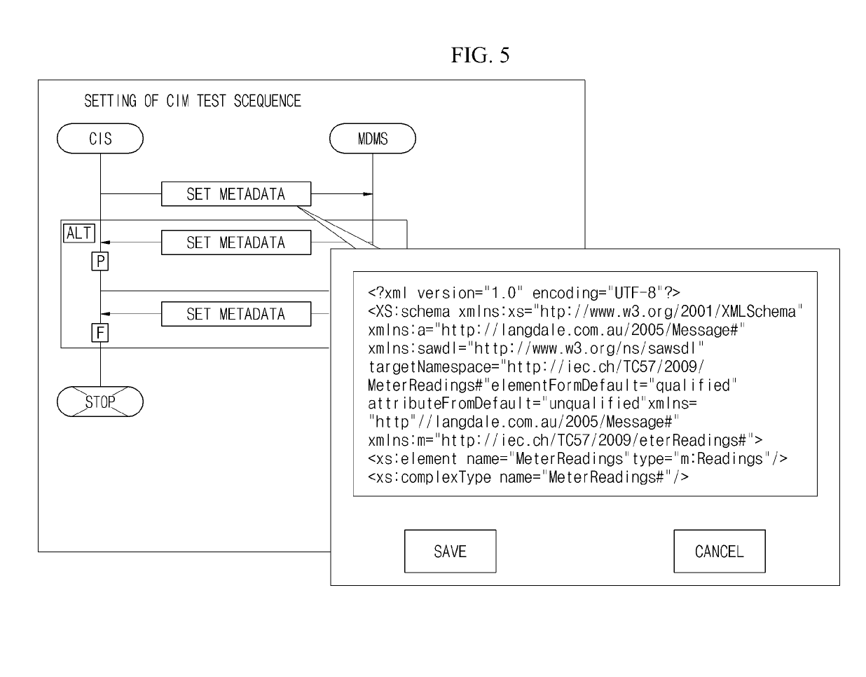

FIG. 5 is a view showing an example of a user interface provided to set common information model metadata based on the test sequence for test automation according to an embodiment of the present invention of FIG. 2.

As shown in FIG. 5, the CIM scenario creation unit 110 provides a user interface for setting a CIM message to test and verify CIM interoperability based on the test sequence between the test target nodes. Here, the user interface may be used to set message comparison and analysis metadata based on the test sequence configured via a test sequence setting screen.

The scenario execution engine unit 102 interprets an execution script based on the test sequence between the nodes to execute the test scenario depending on a scenario environment set by the CIM scenario creation unit 110.

In this case, the CIM message monitoring unit 130 receives a CIM message generated from the test target nodes to monitor a message delivered during a process of routing the CIM message and deliver the message to the CIM testing unit 140.

The CIM testing unit 140 compares a user-defined common information model message set by the CIM test scenario creation unit 110 (metadata storing a CIM message for comparison and analysis) with the CIM message monitored by the CIM message monitoring unit 130 and automatically create a test result.

For example, the CIM testing unit 140 compares the CIM message outputted as a result of the scenario execution with the CIM message defined by a user based on the test sequence and outputs a result of verifying whether the CIM message outputted as a result of the scenario execution is included in the CIM message defined by a user on the basis of the test sequence.

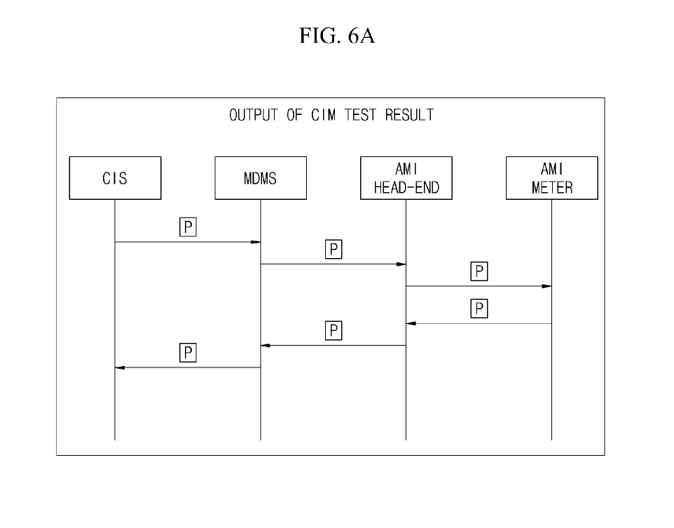

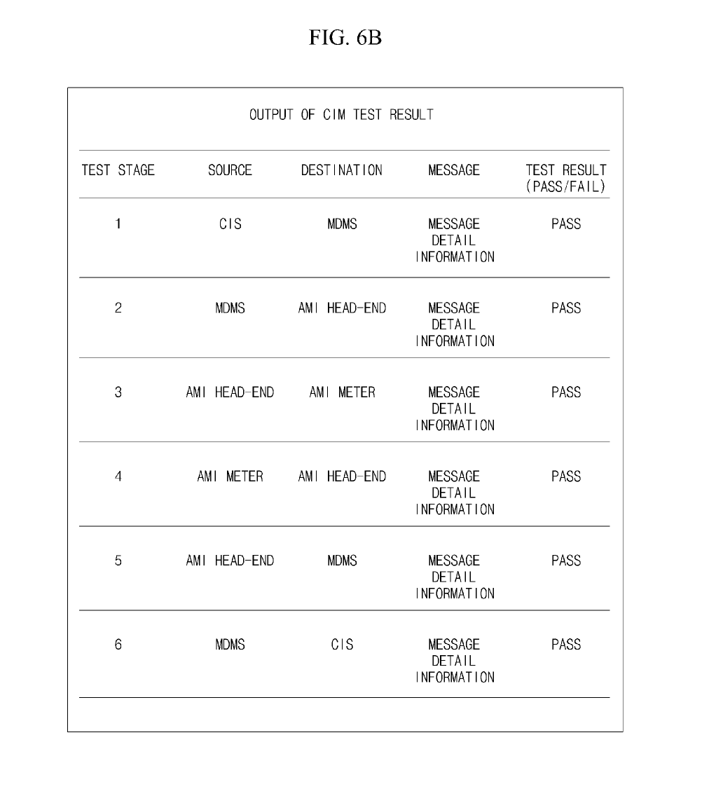

Embodiments of the output result will be described with reference to FIG. 6. FIG. 6a is a view showing an example of a user interface in which a test result is output according to an embodiment of the present invention of FIG. 2, and FIG. 6b is a view showing another example of a user interface in which a test result is output according to an embodiment of the present invention of FIG. 2.

FIG. 6a shows an interface in which a result of verifying a common information model message transmitted between the test target nodes is outputted based on the test sequence using a sequence diagram.

FIG. 6b shows an interface in which information on a source node that creates the common information model message based on the test sequence between the test target nodes, information on a destination node that receives the common information model message, the common information model message information, and verification result information on whether the common information model message is included in the user-defined common information model message.

FIG. 2 is a flowchart showing a method of automating a smart grid common information model interoperability test according to an embodiment of the present invention.

Referring to FIG. 2, the smart grid common information model interoperability test automation method a according to another aspect of the present invention includes a test scenario creation operation S10 to S30 that provides a user interface for setting a test scenario environment in a smart grid environment including test target nodes such as an apparatus, a system, and an application, a monitoring operation S40 that executes the created test scenario to monitor a common information model message outputted from each of the test target nodes, and a test result output operation S50 that compares the monitored common information model message with a user-defined common information model message set in the test scenario creation operation.

As described above, the test scenario creation operation includes an operation S10 that sets test target nodes, an operation S20 that sets a test sequence between the test target nodes, and an operation S30 that sets a common information model message created by the test target nodes on the basis of the test sequence.

The operation S50 may include outputting a result of verifying whether the common information model message transmitted between the test target nodes is included in the user-defined common information model message on the basis of the test sequence using a sequence diagram.

In addition, the operation S50 may also be configured to output information on a source node that creates the common information model message based on the test sequence between the test target nodes, information on a destination node that receives the common information model message, the common information model message information, and verification result information on whether the common information model message is included in the user-defined common information model message.

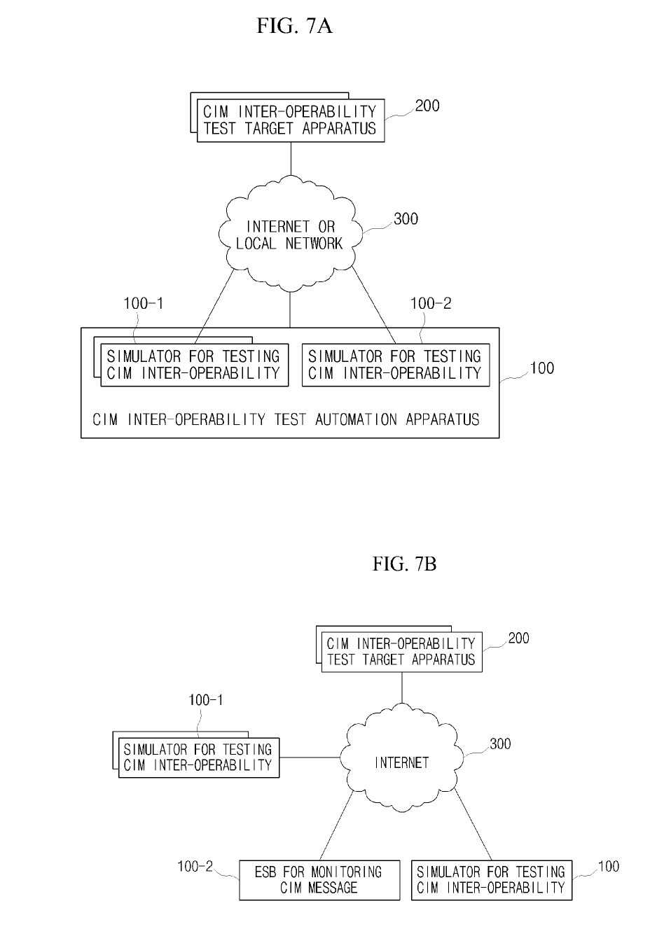

A system environment using an apparatus for automating a smart grid common information model interoperability test according to an embodiment of the present invention will be described below with reference to FIG. 7.

FIGS. 7a and 7b are views showing an example of a test environment configuration established using the smart grid common information model interoperability test automation apparatus according to an embodiment of the present invention.

Referring to FIG. 7a, a system environment is shown including a common information model (CIM) interoperability test automation apparatus that creates metadata for comparing and analyzing CIM messages set by a tester on the basis of a test sequence in a smart grid interoperability test scenario and performs a CIM interoperability test and verification, a CIM interoperability test target apparatus 200, and the Internet or a local network 300 connecting the apparatus 100 and CIM interoperability test apparatus 200.

Here, the CIM interoperability test automation apparatus 100 includes a simulator 100-1 for testing CIM interoperability and an enterprise service bus (ESB) 100-2 for monitoring a CIM message.

The CIM interoperability test target apparatus 200 may include a meter data management system (MDMS), a customer information system (CIS), a metering system (AMI Head-End), an outage management system, and a load management system.

As shown in FIG. 7b, the simulator 100-1 for testing CIM interoperability and an enterprise service bus (ESB) 100-2 for monitoring a CIM message may be driven in another apparatus separately from the CIM interoperability test automation apparatus 100.

The smart grid common information model interoperability test automation method according to the present invention can also be implemented as computer readable codes on a computer readable recording medium. The computer readable recording medium includes all kinds of recording medium for storing data that can be thereafter read by a computer system. Examples of the computer readable recording medium may include a read only memory (ROM), a random access memory (RAM), a magnetic disk, a flash memory, optical data storage device, etc. Also, the computer readable recording medium can also be distributed throughout a computer system connected over a computer communication network so that the computer readable codes may be stored and executed in a distributed fashion.

According to the present invention, it is possible to allow a tester to easily establish a test environment needed to test a CIM interoperability by providing a function that allows a tester to directly set and create test target nodes, a CIM test sequence, and metadata base on the CIM test sequence, and it is also possible to reduce time and cost taken to test and verify the CIM interoperability by automatically compare and analyze a CIM message monitored in an actual test process with CIM message metadata set in a test scenario creation stage.

It will be understood by those skilled in the art that various changes in form and details may be made therein without departing from the spirit and scope of the invention as defined by the appended claims. The above embodiments are accordingly to be regarded as illustrative rather than restrictive. Therefore, the scope of the invention is defined not by the detailed description of the invention but by the appended claims, and a variety of embodiments within the scope will be construed as being included in the present invention.

What is claimed is:

1. An apparatus for automating a smart grid common information model interoperability test, the apparatus comprising:
a common information model test scenario creation unit configured to provide a user interface for setting a test scenario environment in a smart grid environment including test target nodes such as an apparatus, a system, and an application;
a scenario execution engine unit configured to execute a test scenario created by the common information model test scenario creation unit;
a common information model message monitoring unit configured to monitor a common information model message, outputted from each of the test target nodes, as a result of the execution of the test scenario; and
a common information model testing unit configured to compare the common information model message monitored by the common information model message monitoring unit with a user-defined common information model message set by the common information model test scenario creation unit.

2. The apparatus of claim 1, wherein the common information model test scenario creation unit provides at least one of a user interface for setting test target nodes and a user interface for setting a test sequence between the test target nodes.

3. The apparatus of claim 1, wherein the common information model test scenario creation unit provides a user interface for setting a common information model message created in a test scenario by the test target nodes.

4. The apparatus of claim 3, wherein the common information model message is set for the test target nodes based on the test sequence in the test scenario.

5. The apparatus of claim 1, wherein the user-defined common information model message is stored in a form of metadata.

6. The apparatus of claim 1, wherein the common information model testing unit outputs a result of verifying a common information model message transmitted between the test target nodes based on the test sequence, using a sequence diagram.

7. The apparatus of claim 1, wherein the common information model scenario creation unit provides a user interface for setting the test target nodes, a test sequence between the test target nodes, and a user interface for setting the common information model message created based on the test sequence by the test target nodes.

8. A method of automating a smart grid common information model interoperability test, the method comprising:
performing a test scenario creation operation of providing a user interface for setting a test scenario environment in a smart grid environment including test target nodes such as an apparatus, a system, and an application;
executing the created test scenario to monitor a common information model message outputted from each of the test target nodes; and
performing a test result output operation of comparing the monitored common information model message with a user-defined common information model message set in the test scenario creation operation to automatically create a test result.

9. The method of claim 8, wherein the test scenario creation operation comprises:
(a) setting the test target nodes;
(b) setting a test sequence between the test target nodes; and
(c) setting a common information model message created based on the test sequence by the test target nodes.

10. The method of claim 8, wherein the test result output operation comprises outputting a result of verifying whether the common information model message transmitted between the test target nodes is included in the user-defined common information model message, based on the test sequence, using a sequence diagram.

11. The method of claim 8, wherein the test result output operation comprises information on a source node that creates the common information model message based on the test sequence between the test target nodes, information on a destination node that receives the common information model message, the common information message information, and verification result information on whether the common information model message is included in the user-defined common information model message.
